(19) United States
(12) Patent Application Publication
(10) Pub. No.: US 2011/0191281 A1
(43) Pub. Date: Aug. 4, 2011

(54) APPARATUS AND METHOD FOR PREDICTING CHANNEL STATUS BASED ON COGNITIVE RADIO

(75) Inventors: Chang-Hyun Park, Seoul (KR); Sang-Won Kim, Daejon (KR); Myung-Sun Song, Daejon (KR)

(73) Assignee: ELECTRONICD AND TELECOMMUNICATIONS RESEARCH INSTITUTE, Daejeon (KR)

(21) Appl. No.: 12/674,667

(22) PCT Filed: Jun. 27, 2008
(86) PCT No.: PCT/KR08/03746

§ 371 Date: Apr. 14, 2011

(30) Foreign Application Priority Data
Aug. 23, 2007 (KR) 10-2007-0085011

(51) Int. Cl. G06N 5/02

(52) U.S. Cl. 706/52

(57) ABSTRACT

There is provided an apparatus for predicting a channel status, the apparatus including: an input means for receiving information on previous status of a predetermined channel to be predicted; a parameter calculating means for calculating a model parameter that maximizes an occurrence probability of the received previous status; a likelihood calculating means for calculating a likelihood value for each status, based on the calculated model parameter; and a channel predicting means for selecting a previous status having a highest calculated likelihood among the received previous statuses and deciding the selected previous status as a next channel status of the channel.

### TECHNICAL FIELD

The present invention relates to an apparatus and method for predicting channel status based on cognitive radio; and, more particularly, to an apparatus and method for predicting channel statuses based on cognitive radio, which effectively and intelligently determine whether to allocate a channel to a cognitive radio user by calculating probabilistic correlation between a current channel status and previous channel statuses using a Baum-Welch algorithm in cognitive radio technology and predicting a future channel status based on the calculated probabilistic correlation using a forward algorithm.

This work was supported by the IT R&D program of MIC/IITA [2005-S-002-03, “Development of cognitive radio technology for efficient spectrum utilization”].

### BACKGROUND ART

Radio Frequency (RF) resources are a nation's finite intangible asset. As the demand of the RF resource is increased, the value of RF resource is also going up considerably. Numerous wireless communication services have been introduced. The demand for the finite RF resource is increasing with the increase of wireless communication services, such as wireless communication, wireless local area network (WLAN), digital broadcasting, satellite communication, Radio Frequency Identification/Ubiquitous Sensor Network (RFID/USN), Ultra Wide-Band (UWB) communication, and wireless broadband (WiBro).

In order to effectively use such valuable RF resources, advanced countries, including the United States, have already developed related technologies as a national scientific project. Also, many movements are in progress to establish related RF policies.

Conventionally, RF policies were defined and managed by the government. That is, RF policies have been made based on command-and-control. However, it is expected that the RF policies will change to an open spectrum policy.

As a part, a Cognitive Radio technology was introduced by Joseph Mitola III to improve efficiency of spectrum usage. The Cognitive Radio technology is equivalent to an advanced version of software defined radio (SDR) technology

Listen Before Talk (LBT) of Radio Frequency Identification (RFID) or Dynamic Frequency Selection (DFS) in WLAN was introduced as a novice level of Cognitive Radio technology. Mitola III completed the Cognitive Radio technology systematically in his a thesis for a degree.

In “Cognitive Radio Circle”, a wireless communication device observes spectrum around thereof, recognizes peripheral statuses based on the observation result, and decides a priority based on the recognized peripheral states according to a given scheme.

For example, if it is required to be processed immediately according to a given priority, a related process is performed instantly. Also, if it is urgent, a related decision is first made and a related process is then performed. Furthermore, if it is normal, a plan is first made and a related process is then performed.

In order to apply “Cognitive Radio Circle” to RF resources, RF spectrum is observed and a spectrum hole is searched from the observation result. A bandwidth of the spectrum hole and a communication procedure must be additionally decided.

Also, it is needed to discuss about power control, a transmission scheme according to a bandwidth, and a data rate. Furthermore, it is required to develop a method for changing a frequency if there is a user having highest priority.

As a related technology of the Cognitive Radio technology, the present invention discloses a method for predicting a channel status using a Baum-Welch algorithm and a forward algorithm.

### DISCLOSURE OF INVENTION

### Technical Problem

An embodiment of the present invention is directed to providing an apparatus and method for predicting channel status based on cognitive radio, which effectively and intelligently determine to allocate a channel to a cognitive radio user by calculating probabilistic correlation current channel status and previous channel status using Baum-Welch algorithm in cognitive radio technology and predicting future channel status based on the calculated probabilistic correlation using a forward algorithm.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided an apparatus for predicting a channel status, the apparatus including: an input means for receiving information on previous status of a predetermined channel to be predicted; a parameter calculating means for calculating a model parameter that maximizes an occurrence probability of the received previous status; a likelihood calculating means for calculating a likelihood value for each status, based on the calculated model parameter; and a channel predicting means for selecting a previous status having a highest calculated likelihood among the received previous statuses and deciding the selected previous status as a next channel status of the channel.

In accordance with another aspect of the present invention, there is provided a method for predicting a channel status based on cognitive radio, the method including: receiving information on previous status of a predetermined channel to predict; calculating a model parameter that maximizes an occurrence probability of the received previous status; calculating a likelihood value for each status, based on the calculated model parameter; and selecting a previous status having a highest calculated likelihood among the received previous statuses and deciding the selected previous status as a next channel status of the channel.

### Advantageous Effects

An apparatus and method for predicting channel status based on cognitive radio in accordance with the present invention can effectively and intelligently determine to allocate a channel to a cognitive radio user by calculating probabilistic correlation current channel status and previous channel status using Baum-Welch algorithm in cognitive radio technology and predicting future channel status based on the calculated probabilistic correlation using a forward algorithm.

In addition, a future channel status can be predicted in real time using a previous channel status record and a Hidden Markov Model (HMM) algorithm in accordance with the present invention. Furthermore, it is possible to reduce a time and a computation amount compared to a conventional method using ‘Bayesian rule’ and ‘Markov Process’.

Moreover, the present invention can be applied not only to predict a channel status but also to solve another problem if temporal data information is given.

### BRIEF DESCRIPTION OF THE DRAWINGS

FIG. 1 is a block diagram illustrating an apparatus for predicting a channel status based on Cognitive Radio in accordance with an embodiment of the present invention.

FIG. 2 is a diagram illustrating HMM status used in the present invention.

FIG. 3 is a bar graph showing previous channel status information in accordance with an embodiment of the present invention.

FIG. 4 is a diagram illustrating a method for predicting a channel status based on Cognitive Radio in accordance with an embodiment of the present invention.

FIG. 5 is a bar graph showing a result of predicting a channel status based on Cognitive Radio in accordance with an embodiment of the present invention.

FIG. 6 is a user interface of a program for an apparatus for predicting a channel status based on Cognitive Radio in accordance with an embodiment of the present invention.

### BEST MODE FOR CARRYING OUT THE INVENTION

The advantages, features and aspects of the invention will become apparent from the following description of the embodiments with reference to the accompanying drawings, which is set forth hereinafter. Therefore, those skilled in the art can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

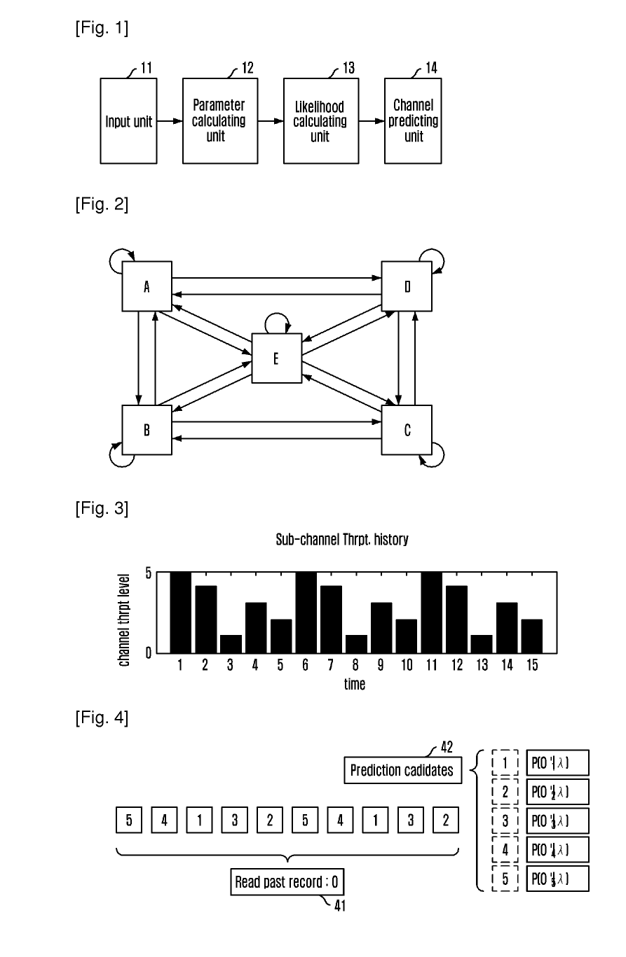

FIG. 1 is a block diagram illustrating an apparatus for predicting a channel status based on cognitive radio in accordance with an embodiment of the present invention.

Referring to FIG. 1, the apparatus in accordance with the present embodiment includes an input unit 11, a parameter calculating unit 12, a likelihood calculating unit 13, and a channel predicting unit 14. The input unit 11 receives information on a previous channel status of a target channel to be predicted. The parameter calculating unit 12 calculates a Hidden Markov Model (HMM) parameter λ that maximizes the occurrence probability of the received previous channel status. The likelihood calculating unit 13 calculates likelihood values by applying a forward algorithm to each status of a channel based on the calculated optimal HMM parameter. The channel predicting unit 14 selects the highest one of the calculated likelihood values and predicts a next channel status of the target channel as the previous channel status having the selected likelihood value.

The parameter calculating unit 12 uses a Baum-Welch algorithm to learn the previous channel status from the input unit 11. That is, the parameter calculating unit 12 finds a model parameter λ that maximizes the occurrence probability of the previous channel status.

That is, the parameter calculating unit 12 estimates a transition probability, an output status probability, and an initial status probability using the information on the received previous channel status. Then, the parameter calculating unit 12 calculates a likelihood value based on the estimated probabilities. The parameter calculating unit 12 finds the optimal HMM parameter λ by repeating the above operations until the calculated likelihood value becomes high.

Hereinafter, the terms used herein will be defined prior to the description of the method for predicting the channel status based on Cognitive Radio.

In

λ=(A,B,π),

λ denotes a model parameter, Adenotes a transition probability between statuses, B denotes an occurrence probability of an observed status, and

π

is an initial occurrence probability of each status.

In O=O₁, O₂, . . . , O_{T}, O denotes a set of previous channel statuses arranged temporally.

In

αₜ(i)=P{O₁O₂, . . . ,Oₜ,qₜ=i|λ}, αₜ(i)

denotes a probability that a channel status will be i at time t and the observed status sequence (status information sequence) O will occur, when a model parameter is given.

In

βₜ(i)=P{(Oₜ₊₁,Oₜ₊₂, . . . ,O_{T}|qₜ=i|λ}, βₜ(i)

is a probability that the observed status sequence Oₜ₊₁, Oₜ₊₂, . . . , O_{T} will occur when a model parameter and a status i at time t are given.

In

ζₜ(i,j)=p{qₜ=i,qₜ₊₁=j|O,λ}, ξₜ(i,j)

is a probability that a status will be i at a given time t and a status will be j at a given time t+1, when the model parameter and the observed status sequence are given.

In

γₜ(i)=p{qₜ=i|Oλ}, γₜ(i)

is a probability that a status will be i at a given time t when the model parameter and the observed status sequence are given.

Accordingly,

εₜ(i,j)

can be expressed as the following Equation 1.

$${ξ}_{t} ( i , j ) = \frac{{α}_{t} ( i ) {a}_{ij} {β}_{t + 1} ( j ) {b}_{j} ( {o}_{t + 1} )}{{\sum }_{i = 1}^{N} {\sum }_{j = 1}^{N} {α}_{t} ( i ) {a}_{ij} {β}_{t + 1} ( j ) {b}_{j} ( {o}_{t + 1} )} \qquad Eq . 1$$

Equation 1 shows a probability that a status will be i at time t and a status will be j at time t+1 among all statuses that could occur at time t and time t+1.

Also,

γₜ(i)

can be expressed as the following Equation 2.

$${γ}_{t} ( i ) = [ \frac{{α}_{t} ( i ) {β}_{t} ( i )}{{\sum }_{i = 1}^{N} {α}_{t} ( i ) {β}_{t} ( i )} ] \qquad Eq . 2$$

Equation 2 is a probability that a status will be i among all status that could occur at time t.

Hereinafter, the method for predicting the channel status based on cognitive radio in accordance with an embodiment of the present invention will be described with reference to FIGS. 2 and 3.

First, information on a previous channel status of a target channel to be predicted is received. That is, the information on the previous channel status as shown in FIG. 3 is received from a record storage unit. The received information is the observed status sequence O.

Then, a Hidden Markov Model (HMM) parameter that maximizes the occurrence probability of the received previous status is calculated. That is, a transition probability between statuses, an output status probability, and an initial status probability are statistically calculated using a Baum-Welch algorithm, based on the received observed status sequence and the HMM status structure shown in FIG. 2.

That is, a probability that a channel will be in a status i at an initial stage is calculated, based on the following Equation 3.

π̅ᵢ=γ₁(i),1≦i≦N Eq. 3

Also, a probability that a status i will transit to a status j is calculated by summing the probabilities that a status i will occur and then a status j will occur at all time, based on the following Equation 4.

$${\overline{a}}_{ij} = \frac{{\sum }_{t = 1}^{T - 1} {ξ}_{t} ( i , j )}{{\sum }_{t = 1}^{T - 1} {γ}_{t} ( i )} , 1 \leq i \leq N , 1 \leq j \leq N \qquad Eq . 4$$

Furthermore, a probability that a k symbol will be generated at a state j is calculated, based on the following Equation 5. That is, the probability is calculated by dividing a sum of probabilities that an output symbol will be

νₖ

with a channel status j by the sum of probabilities that a channel will be a status j at all time.

$${\overline{b}}_{j} ( k ) = \frac{{\sum }_{{t = 1}_{{O}_{t} = {V}_{k}}}^{T} {γ}_{t} ( j )}{{\sum }_{t = 1}^{T} {γ}_{t} ( j )} , 1 \leq j \leq N , 1 \leq k \leq M \qquad Eq . 5$$

It is possible to optimize

âᵢⱼ,\hat{b}ⱼ(k),\hat{π}ᵢ

(i,j: status, k: time) through Equations 3 to 5.

Then, a likelihood value is calculated by applying a forward algorithm for each status of a channel based on the calculated optimal HMM parameter.

Hereafter, the forward algorithm will be described in more detail.

The forward algorithm refers to a probability that a channel will be a status i and an observed symbol sequence will be generated when a model parameter is given.

A forward variable may be defined as a probability of a partial observed status sequence. It is assumed that the partial observed status sequence ends with a channel state i at time t like the following Equation 6.

aₜ(i)=p{o₁,o₂, . . . ,oₜ,qₜ=i|λ} Eq. 6

Then, the following Equation 7 is repeatedly performed.

$${a}_{t + 1} ( j ) = {b}_{j} ( {a}_{t} + 1 ) {\sum }_{i = 1}^{N} {a}_{t} ( i ) {a}_{ij} , 1 \leq j \leq N , 1 \leq t \leq T - 1 \qquad Eq . 7$$

An initial status is expressed as the following Equation 8.

a₁(j)=πⱼbⱼ(o₁),1≦j≦N Eq. 8

After repeatedly performing the above operation, the result will be given by the following Equation 9.

a_{T}(i),1≦i≦N Eq. 9

Finally, a likelihood probability will be expressed as the following Equation 10.

$$p \{ O \vert λ \} = {\sum }_{i = 1}^{N} {a}_{T} ( i ) \qquad Eq . 10$$

Then, a previous status having the highest calculated likelihood value is selected as the next status of the channel.

Hereinafter, the method for predicting the channel status based on cognitive radio will be described in more detail with reference to FIGS. 4 to 6.

Referring to FIG. 4, it is assumed that there are 5 observed statuses and 5 virtual statuses. It is also assumed that an observed status sequence O is {5, 4, 1, 3, 2, 5, 4, 1, 3, 2}.

First, the HMM parameter

λ

is optimized based on the observed status sequence O using the Baum-Welch algorithm. If the number of prediction candidates 42 is five, the likelihood

P(O′|λ)

for each of the prediction candidates 42 is calculated. Then, an observed status sequence having the highest likelihood is selected as the next status of the target channel.

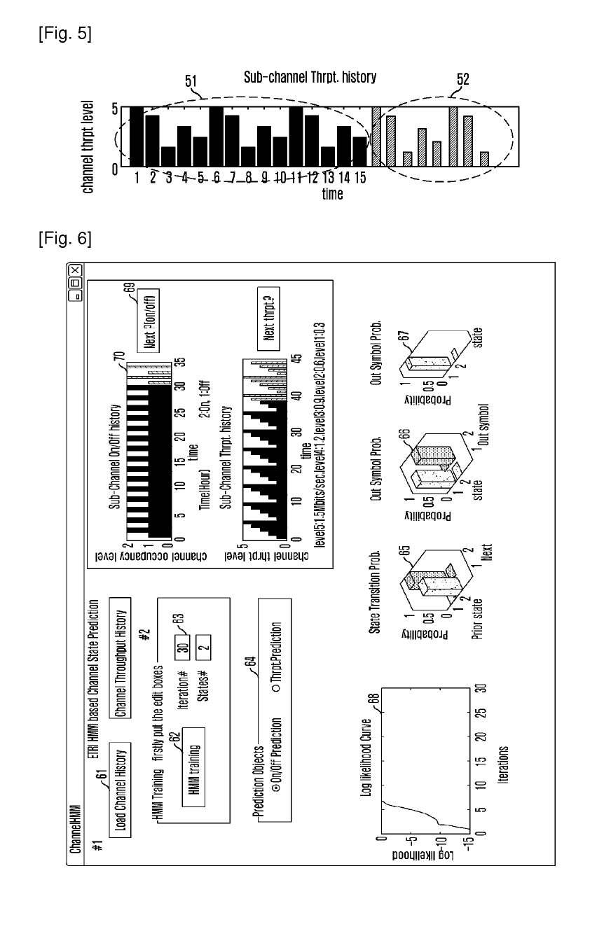

FIG. 5 shows a simulation result when the next status of the channel is predicted through the above operations.

As shown in FIG. 5, a bar graph shows that predicted channel throughput levels 52 are progressed identically to past channel throughput level pattern 51.

FIG. 6 is a diagram illustrating a user interface of a program for the apparatus for predicting the channels status based on cognitive radio in accordance with an embodiment of the present invention.

As shown in FIG. 6, a reference numeral 61 is a button for reading previous statuses of a target channel. In a block 64, a left radio button is provided for on/off status of a channel, and a right radio button is provided for reading a record about ‘throughput’.

The number of maximum repetition of HMM learning and the number of statuses can be set through input boxes in an editing window 63. As shown, the number of maximum repetition of HMM learning and the number of statuses are set to 30 and 2 as a default. If a HMM training button 62 is activated, a learning procedure starts based on the previous record.

An object of learning can be setup through a radio button 64. When the learning procedure starts, blocks 65, 66, and 67 show the transition probability, the output symbol probability, and the initial state probability in real time. A graph 68 shows a ‘log likelihood’ curve at every ‘iteration’. Herein, the optimal learning is archived when the transition curve is converged to 0.

A button 69 is provided for deciding the next status after completely ending the learning procedure. If the button 69 is activated, the predicted next state is expressed through a bar graph 70.

The present application contains subject matter related to Korean Patent Application No. 2007-0085011, filed in the Korean Intellectual Property Office on Aug. 23, 2006, the entire contents of which is incorporated herein by reference.

The above-described method in accordance with the present invention can be embodied as a program and stored on a computer-readable recording medium. Codes and code segments for accomplishing the present invention can be easily construed by programmers skilled in the art to which the present invention pertains. Also, the computer program is stored in a computer-readable recording medium or information storing medium and read and executed by a computer to realize the method in accordance with the present invention. Examples of the recording medium include all types of computer-readable recording media.

While the present invention has been described with respect to the specific embodiments, it will be apparent to those skilled in the art that various changes and modifications may be made without departing from the spirit and scope of the invention as defined in the following claims.

1. An apparatus for predicting a channel status, the apparatus comprising:
an input means for receiving information on previous status of a predetermined channel to be predicted;
a parameter calculating means for calculating a model parameter that maximizes an occurrence probability of the received previous status;
a likelihood calculating means for calculating a likelihood value for each status, based on the calculated model parameter; and
a channel predicting means for selecting a previous status having a highest calculated likelihood among the received previous statuses and deciding the selected previous status as a next channel status of the channel.

2. The apparatus of claim 1, wherein the parameter calculating means uses a Baum-Welch algorithm to calculate the model parameter.

3. The apparatus of claim 2, wherein the model parameter is a Hidden Markov Model (HMM) parameter.

4. The apparatus of claim 3, wherein the parameter calculating means estimates a transition probability, an output status probability, and an initial status probabilities using the received previous statuses, and calculates a HMM parameter that maximizes the occurrence probability of the previous statuses.

5. The apparatus of claim 1, wherein the likelihood calculating means uses a forward algorithm for each status of a channel to calculate the likelihood value.

6. A method for predicting a channel status based on cognitive radio, the method comprising:
receiving information on previous status of a predetermined channel to predict;
calculating a model parameter that maximizes an occurrence probability of the received previous status;
calculating a likelihood value for each status, based on the calculated model parameter; and
selecting a previous status having a highest calculated likelihood among the received previous statuses and deciding the selected previous status as a next channel status of the channel.

7. The method of claim 6, wherein the model parameter is calculated using a Baum-Welch algorithm.

8. The method of claim 7, wherein the model parameter is a Hidden Markov Model (HMM) parameter.

9. The method of claim 8, wherein said calculating of the parameter model comprises:
estimating a transition probability, an output status probability, and an initial status probability by using the previous status; and
calculating a HMM parameter that maximizes the occurrence probability of the previous statuses.

10. The method of claim 6, wherein the likelihood value is calculated by applying a forward algorithm to each status of a channel.
